(19) United States
(12) Patent Application Publication
(10) Pub. No.: US 2015/0129332 A1
(43) Pub. Date: May 14, 2015

(54) BATTERY PACK, METHOD FOR PRODUCING SAME, ELECTRIC VEHICLE PROVIDED WITH SAID BATTERY PACK, AND POWER STORAGE DEVICE

(71) Applicant: SANYO Electric Co., Ltd, Osaka (JP)

(72) Inventors: Takashi Seto, Hyogo (JP); Eiji Okutani, Hyogo (JP); Kazuhiro Fujii, Hyogo (JP)

(21) Appl. No.: 14/400,554

(22) PCT Filed: Jul. 31, 2013
(86) PCT No.: PCT/JP2013/004632

§ 371 Date: Nov. 12, 2014

(30) Foreign Application Priority Data
Aug. 9, 2012 (JP) 2012-176713

(51) Int. Cl. H01M 10/04; H02J 7/00; B60L 11/18

(52) U.S. Cl. CPC H01M 10/0468; H01M 10/0431; B60L 11/1879; H01M 10/049; B60L 11/1877; B60L 11/1809; H02J 7/0013; H02J 7/007; H01M 2220/20
USPC 180/65.1; 156/191; 429/94; 320/112

(57) ABSTRACT

A battery pack comprises a battery staked member stacking a plurality of flat secondary batteries, end plates being disposed at both ends of the battery staked member, and binding bars being coupled to the end plates in a pressed state that the flat secondary batteries of the battery staked member are compressed and fixed in a predetermined binding pressure. The flat secondary batteries constituting the battery staked member comprise an electrode assembly of a spiral form in which a positive electrode plate and a negative electrode plate interposing a separator therebetween are wound, and an outer case airtightly storing the spiral electrode assembly and an electrolyte. The spiral electrode assemblies of the flat secondary batteries are pressed and made into a flat shape by a higher pressing pressure than the predetermined binding pressure in which the flat secondary batteries are bound by the binding bars.

### CROSS-REFERENCE TO RELATED APPLICATIONS

The present application is a national stage application of international application PCT/JP2013/004632 filed on Jul. 31, 2013, and claims the benefit of foreign priority of Japanese patent application 2012-176713 filed on Aug. 9, 2012, the contents both of which are incorporated herein by reference.

### TECHNICAL FIELD

The present invention is related to a battery pack and a method for manufacturing the same in which a plurality of flat secondary batteries are stacked, especially, the battery pack and the method for manufacturing the same in which a battery stacked member stacking the flat secondary batteries is fixed in the pressed state by end plates at both ends thereof.

### BACKGROUND ART

A flat secondary battery in which an electrode assembly and an electrolyte as elements of generation of electricity are sealed in an outer case having a rectangular box shape, is developed (refer to patent literature 1).

In the flat secondary battery, the electrode assembly is swollen by charging and discharging. Concretely, the electrode assembly is swollen by charging the flat secondary battery, and is contracted by discharging the flat secondary battery. Further, active layers of the electrode assembly are swollen also by repeatedly charging and discharging.

As the power source having a high output or a high capacity in which this type of the secondary battery is used, a battery pack in which a plurality of the flat secondary batteries are stacked, is developed (refer to patent literature 2).

In this battery pack, a volume efficiency is high, and an energy density to volume is high. Concretely, by connecting the stacked flat secondary battery in series, the output voltage is increased, and by connecting the stacked flat secondary battery in parallel, the capacity is increased. In this battery pack, a plurality of the flat secondary batteries are stacked through insulating member as the battery staked member, and end plates are disposed at both ends of the battery staked member, and the end plates are coupled by binding bars, and the flat secondary batteries are fixed in the stacked state. As mentioned above, the flat secondary battery is swollen by charging and discharging, or the degradation of the battery, the deformation or swell of the battery stacked member is prevented by the end plates and the binding bars in the battery pack.

### CITATION LIST

### Patent Literature

Patent Literature 1: Japanese Laid-Open Patent Publication No. 2012-109219

Patent Literature 2: Japanese Laid-Open Patent Publication No. 2011-23301

### SUMMARY OF THE INVENTION

In a battery pack fixed in a staked state of alternately stacking a plurality of flat secondary batteries and an insulating material, the flat secondary batteries are compressed and fixed in a predetermined binding pressure from both sides, by binding bars being coupled to end plates at both ends of a battery stacked member. In order to fix the flat secondary batteries in a compressed state, the battery pack is assembled in the following steps.
(1) The plurality of the flat secondary batteries interposing insulating materials are stacked, and then the battery stacked member is made.
(2) The end plates are disposed at both ends of the battery stacked member, and a pair of the end plates are pressed by a press machine in the stacked direction of the flat secondary batteries.
(3) In a state that the battery stacked member is pressed, the binding bars are coupled to a pair of the end plates. After the flat secondary batteries are held in a predetermined binding pressure by a pair of the end plates coupled to the binding bars, the press machined is removed.

However, when the flat secondary batteries are compressed in the predetermined binding pressure, the binding pressure is also applied to an electrode assembly which is stored in an outer case. Therefore, it happens that distances between electrode plates in a state of the battery stacked member with external pressure is shorter than distances between electrode plates in a state of the flat secondary battery of a single body without external pressure, depending on value of the binding pressure, and it is likely to influence the battery property. As binding of the binding bars and the end plates is carried out in order to made the battery stacked member within a predetermined size, the binding pressure does not necessarily become constant. Therefore, when the battery packs are manufactured, there is a problem that dispersion or differences among the battery packs in the battery property happen. Further, also in a structure to suppress or reduce dispersion or differences among the battery packs in the battery property by the binding pressure being made constant, there is a problem that dispersion or differences among sizes of the battery stacked members become bigger. When design or manufacturing allowance is big, there are problems that it is difficult to fix the battery pack, etc.

The present disclosure is developed for the purpose of providing the battery pack which reduces or suppresses an influence of the battery property, and prevents a deformation, a swell, or an expansion of the battery stacked member. One non-limiting and explanatory embodiment provides a battery pack and a method for manufacturing the battery pack, and a vehicle and a storage battery device equipped with the battery pack which in addition to preventing a deformation, a swell, or an expansion of the battery stacked member, reduces or suppresses dispersion or differences of the battery property among the battery packs, or dispersion or differences of the sizes among the battery stacked member.

A battery pack of the present disclosure comprises a battery staked member stacking a plurality of flat secondary batteries, end plates being disposed at both ends of the battery staked member and binding bars being coupled to the end plates in a pressed state that the flat secondary batteries of the battery staked member are compressed and fixed in a predetermined binding pressure. The flat secondary batteries constituting the battery staked member comprise an electrode assembly of a spiral form in which a positive electrode plate and a negative electrode plate interposing a separator therebetween are wound, and an outer case airtightly storing the spiral electrode assembly and an electrolyte. The spiral electrode assemblies of the flat secondary batteries are pressed and made into a flat shape by a higher pressing pressure than the predetermined binding pressure in which the flat secondary batteries are bound by the binding bars.

Accordingly, in addition to preventing a deformation, a swell, or an expansion of the battery stacked member, the battery pack reduces or suppresses dispersion or differences of the battery property among the battery packs, or dispersion or differences of the sizes among the battery stacked member. It is a reason why the spiral electrode assemblies pressed and made into a flat shape by a higher pressing pressure than the predetermined binding pressure in which the flat secondary batteries are bound by the binding bars, are stored into the outer case. As the electrode assembly of the flat secondary battery, the electrode assemblies pressed and made by the high pressing pressure are used, and the binding pressure of the flat secondary battery fixed by the end plates in a stacked state, is set at low value. The binding pressure of the end plated coupled to the binding bars is applied to the outer case of the flat secondary battery, but this binding pressure is lower than the press pressure of the electrode assembly, and then the electrode assembly is not deformed by the binding pressure. Therefore, as the electrode assembly of the flat shape pressed by the press pressure which is higher than the binding pressure, is inserted into the outer case, when the battery stacked member is bound by the end plates and the binding bars, the deformation of the electrode assembly by the binding pressure can be prevented. Further, the decrease of the battery property can be reduced or suppressed in a state of repeatedly charging and discharging, because the pressed electrode assembly stored into the outer case, is pressed in the flat shape by the press pressure higher than the binding pressure. Especially, as the electrode assembly in which the positive electrode plate and the negative electrode are wound in the spiral form interposing the separator therebetween, is pressed and made in the flat shape by the strong press pressure, the positive electrode plate and the negative electrode plate become in a tightly contacted or consolidated state of high density, and then the swell of the electrode assembly is reduced or suppressed. Further, as the electrode assembly is pressed and made in the flat shape by the strong press pressure, the positive electrode plate, the negative electrode plate, and the separator, are made such that the flat plane portions are coupled to the curved portions, and the positive electrode plate and the negative electrode plate are fixed in the tightly contacted or consolidated state of high density, and then the swell of the electrode assembly is effectively prevented. As the swell of the electrode assembly by charging and discharging is reduced or suppressed in the above battery pack, the outer case is not damaged even though the flat secondary batteries are strongly bound. Therefore, the degradation of the battery property is effectively prevented in a long time period, and the life can be made longer.

In the battery pack in the present disclosure, the flat secondary batteries are non-aqueous electrolyte secondary batteries.

Accordingly, as the flat secondary batteries are non-aqueous electrolyte secondary batteries, the decrease of the battery property can be reduced or suppressed even in a state of repeatedly charging and discharging. Especially, as the electrode assembly in which the positive electrode plate and the negative electrode are wound in the spiral form interposing the separator therebetween, is pressed and made in the flat shape by the strong press pressure, the positive electrode plate and the negative electrode plate become in a tightly contacted or consolidated state of high density, and then the swell of the electrode assembly is reduced or suppressed.

In the battery pack in the present disclosure, the non-aqueous electrolyte secondary batteries are lithium ion secondary batteries.

Accordingly, as the non-aqueous electrolyte secondary batteries are lithium ion secondary batteries, while a charging capacity with respect to volume and weight is increased, the swell of the electrode assembly is effectively reduced or suppressed.

In the battery pack in the present disclosure, the pressing pressure of the spiral electrode assemblies is equal to or more than twice the binding pressure of the flat secondary batteries.

Accordingly, as the pressing pressure of the spiral electrode assemblies is equal to or more than twice the binding pressure of the flat secondary batteries, while the electrode assembly is surely pressed into the flat shape, and the battery staked member is bound without the damage of the outer case, the degradation of the battery property by the swell of the electrode assembly is effectively prevented in a state that the electrode assembly is stored into the outer case.

In the battery pack in the present disclosure, the separator of the electrode assembly is a thermoplasticity resin film of porous membrane.

Accordingly, as the electrode assembly in the spiral form is pressed into the flat shape by the strong press pressure, the positive electrode plate and the negative electrode plate become in a tightly contacted or consolidated state of high density. Therefore, the decrease of the battery property by the swell of the electrode assembly can be reduced or suppressed.

In the battery pack in the present disclosure, the outer case comprises an outer can having an opening portion and a sealing plate, and the opening portion of the outer can is airtightly sealed and closed by the sealing plate by laser welding, and the pressed electrode assembly is stored in the outer can in a posture that an winding axis of the spiral form is disposed in parallel with the sealing plate.

Accordingly, the damage of the outer case is surely prevented, since the electrode assembly in the spiral form is swollen or expanded at the center between the sealing plate and the bottom portion, and the connecting portion between the outer can and the sealing plate is not pressed from inside.

In the battery pack in the present disclosure, the end plate is a rectangular shape as a whole shape, and the end plates are coupled to the binding bars at the four corners thereof.

Accordingly, by the end plates and the binding bars, the whole flat secondary battery is fixed in a pressed state by the uniform binding pressure, and demerits by the swell or expansion of the flat secondary battery can be reduced or suppressed.

In the battery pack in the present disclosure, the binding bar is a metal board having a L-shape in a lateral sectional view.

Accordingly, as the bending strength of the binding bar becomes strong, the end plates are disposed at the fixed position, and the flat secondary batteries can be stably pressed and fixed in the stacking direction by the predetermined binding pressure.

A method for manufacturing a battery pack of the preset disclosure comprises a winding step of winding into a spiral electrode assembly a positive electrode plate and a negative electrode plate interposing a separator therebetween, a pressed shaping step of pressing the spiral electrode assembly obtained in the winding step into a flat pressed electrode assembly, a sealing step of airtightly sealing an outer case in a state that the flat pressed spiral electrode assembly obtained in the pressed shaping step is inserted in the outer case and an electrolyte is filled into the outer case, as flat secondary batteries, a stacking step of stacking a plurality of the flat secondary batteries obtained in the sealing step as a battery staked member, and a binding step of binding and fixing in a pressed state of the flat secondary batteries of the battery staked member in a predetermined pressure by disposing end plates at both ends of the battery staked member obtained in the stacking step and coupling binding bars to a pair of the end plates. In the method for manufacturing the battery pack, the spiral electrode assemblies of the pressed shaping step are pressed and made by a stronger pressing pressure than the binding pressure by which the flat secondary batteries are compressed in the binding step.

Accordingly, the spiral electrode assemblies of the pressed shaping step are pressed and made by a stronger pressing pressure than the binding pressure by which the flat secondary batteries are compressed in the binding step. The binding pressure of the end plated coupled to the binding bars in the binding step is applied to the outer case of the flat secondary battery, but this binding pressure is lower than the press pressure of the electrode assembly in the pressed shaping step, and then the electrode assembly is not deformed by the binding pressure. Therefore, in the above method for manufacturing, as the electrode assembly of the flat shape pressed by the press pressure which is higher than the binding pressure, is inserted into the outer case, when the battery stacked member is bound by the end plates and the binding bars, the deformation of the electrode assembly by the binding pressure can be prevented. Further, the decrease of the battery property can be reduced or suppressed in a state of repeatedly charging and discharging, because the pressed electrode assembly stored into the outer case, is pressed in the flat shape by the press pressure higher than the binding pressure. Especially, as the electrode assembly in which the positive electrode plate and the negative electrode are wound in the spiral form interposing the separator therebetween, is pressed and made in the flat shape by the strong press pressure, the positive electrode plate and the negative electrode plate become in a tightly contacted or consolidated state of high density, and then the swell of the electrode assembly is reduced or suppressed. Further, as the electrode assembly is pressed and made in the flat shape by the strong press pressure in the pressed shaping step, the positive electrode plate, the negative electrode plate, and the separator, are made such that the flat plane portions are coupled to the curved portions, and the positive electrode plate and the negative electrode plate are fixed in the tightly contacted or consolidated state of high density, and then the swell of the electrode assembly is effectively prevented. As the swell of the electrode assembly by charging and discharging in the battery pack obtained in the above method for manufacturing is reduced or suppressed, the outer case is not damaged even though the flat secondary batteries are strongly bound. Therefore, the degradation of the battery property is effectively prevented in a long time period, and the life can be made longer.

In the method for manufacturing in the present disclosure, the flat secondary batteries are non-aqueous electrolyte secondary batteries.

Accordingly, as the flat secondary batteries are non-aqueous electrolyte secondary batteries, the decrease of the battery property can be reduced or suppressed even in a state of repeatedly charging and discharging. Especially, as the electrode assembly in which the positive electrode plate and the negative electrode are wound in the spiral form interposing the separator therebetween, is pressed and made in the flat shape by the strong press pressure, the positive electrode plate and the negative electrode plate become in a tightly contacted or consolidated state of high density, and then the swell of the electrode assembly is reduced or suppressed.

In the method for manufacturing in the present disclosure, the non-aqueous electrolyte secondary batteries are lithium ion secondary batteries.

Accordingly, as the non-aqueous electrolyte secondary batteries are lithium ion secondary batteries, while a charging capacity with respect to volume and weight is increased, the swell of the electrode assembly is effectively reduced or suppressed.

In the method for manufacturing in the present disclosure, the pressing pressure of the spiral electrode assembly 11U in the pressed shaping step is equal to or more than 1 M Pa, and equal to or less than 20 M Pa, and this pressing pressure is equal to or more than twice the binding pressure of the flat secondary batteries 1 in the binding step.

Accordingly, as the pressing pressure of the spiral electrode assemblies in the pressed shaping step is equal to or more than twice the binding pressure of the flat secondary batteries in the binding step, while the electrode assembly is surely pressed into the flat shape in the pressed shaping step, and the battery staked member is bound without the damage of the outer case in the binding step, the degradation of the battery property by the swell of the electrode assembly is effectively prevented in a state that the electrode assembly is stored into the outer case.

A vehicle in the present disclosure, comprises any one of the above battery packs, an electric motor being energized by electric power that is supplied from the battery pack, a vehicle body having the battery pack and the electric motor, and a wheel being driven by the electric motor, and driving the vehicle body.

A storage battery device in the present disclosure, comprises any one of the above battery packs, and a power supply controller controlling charging and discharging of the battery pack. The battery pack is charged with an external power by the power supply controller, and charging of the battery pack is controlled by the power supply controller.

### BRIEF DESCRIPTION OF DRAWINGS

FIG. 1 is a perspective view of a battery pack related to an embodiment of the present disclosure.

FIG. 2 is an explored perspective view of the battery pack shown in FIG. 1.

FIG. 3 is a schematic sectional view showing a state of pressing a battery staked member from both sides.

FIG. 4 is an explored perspective view showing a manufacturing step of an electrode assembly.

FIG. 5 is a schematic sectional view showing a manufacturing step of the electrode assembly.

FIG. 6 is a perspective view showing a manufacturing step of the electrode assembly.

FIG. 7 is an explored perspective view showing a manufacturing step of a flat secondary battery.

FIG. 8 is a front view of the flat secondary battery.

FIG. 9 is a schematic vertical longitudinal sectional view showing an internal structure of the flat secondary battery.

FIG. 10 is a schematic vertical lateral sectional view showing an internal structure of the flat secondary battery.

FIG. 11 is a front view of an insulating member.

FIG. 12 is a vertical sectional view showing a stacked structure of the flat secondary batteries and insulating members.

FIG. 13 is an explored sectional view of the flat secondary battery and the insulating members shown in FIG. 12.

FIG. 14 is a main enlarged sectional view of the insulating member shown in FIG. 12.

FIG. 15 is a horizontal sectional view showing a stacked structure of the flat secondary batteries and the insulating member.

FIG. 16 is an explored sectional view of the flat secondary batteries and the insulating member shown in FIG. 12.

FIG. 17 is a block diagram showing one explanatory embodiment of a hybrid car driven by an engine and a motor in which the battery pack is installed.

FIG. 18 is a block diagram showing one explanatory embodiment of an electric car driven only by a motor in which the battery pack is installed.

FIG. 19 is a block diagram showing one explanatory embodiment of a storage battery device using the battery pack.

### DESCRIPTION OF EMBODIMENTS

Hereinafter, the embodiment of the present invention will be described referring to drawings. However, the following embodiments illustrate a battery pack and a method for manufacturing the battery pack, and a vehicle and a storage battery device equipped with the battery pack which are aimed at embodying the technological concept of the present invention, and the present invention is not limited to the battery pack and the method for manufacturing the battery pack, and the vehicle and the storage battery device equipped with the battery pack described below. However, the members illustrated in Claims are not limited to the members in the embodiments.

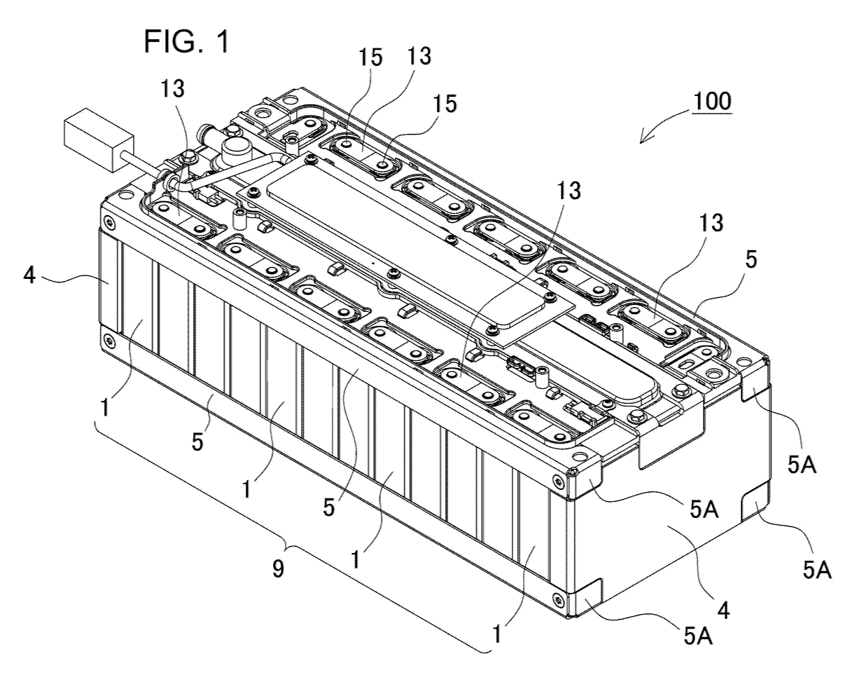

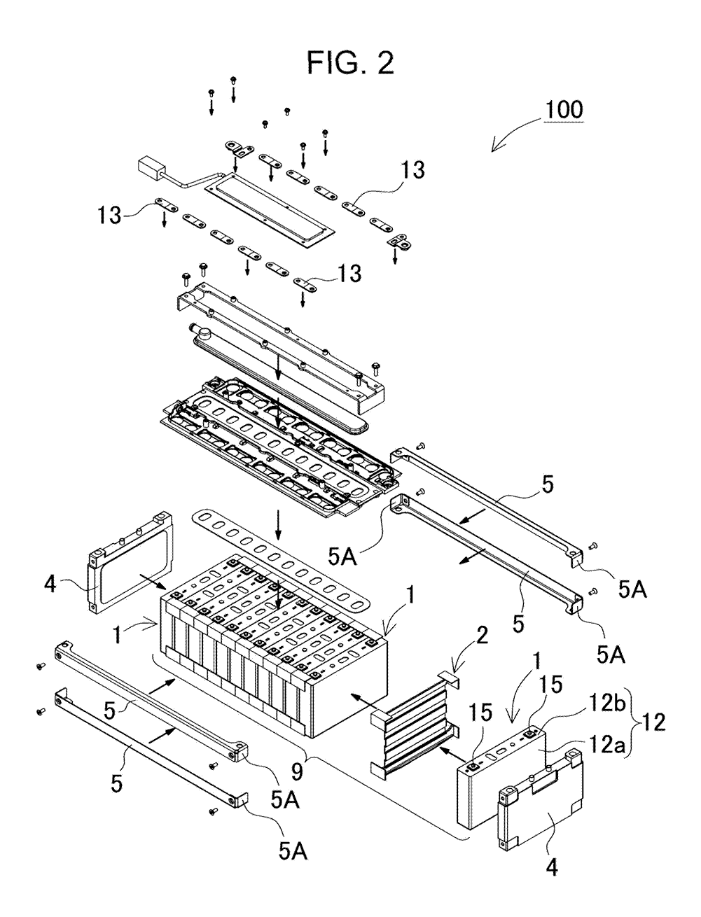

A battery pack 100 of FIG. 1 and FIG. 2 comprises a battery stacked member 9 in which flat secondary batteries 1 and insulating members 2 are alternately stacked, end plates 4 which are disposed at both ends of the battery staked member 9 in the stacked direction, and binding bars coupling the end plates by which the flat secondary batteries 1 of the battery staked member 9 are compressed and fixed in the pressed state in a predetermined binding pressure.

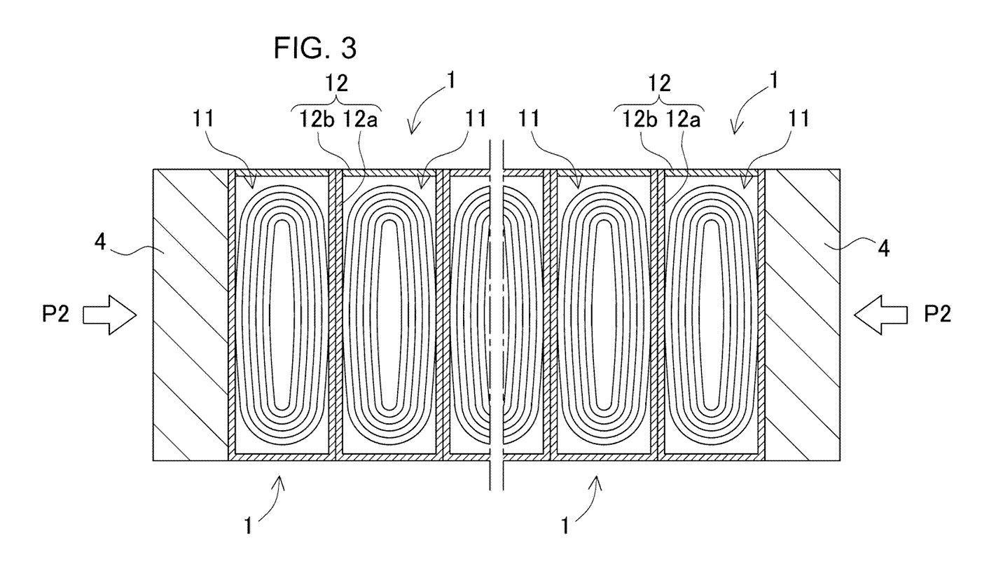

The end plates 4 are disposed at both ends of the battery staked member 9. As shown in the schematic sectional view of FIG. 3, the binding bars 4 are coupled to the end plates 5, and the battery staked member 9 is compressed from both end surfaces, and then each of the flat secondary batteries 1 is compressed and fixed in the pressed state in the stacked direction. The binding bars 5 are coupled to the end plates 4 at both end portions of the binding bars 5, and each of the flat secondary batteries 1 of the battery staked member 9 is compressed and fixed in the pressed state by a predetermined binding pressure (P2). The end plates 4 has the approximately same outer shape as the flat secondary battery 1, or the slightly bigger size than that of the flat secondary battery 1, and the end plates 4 are coupled to the binding bars 4 at the four corners of the end plates 4, and the end plates 4 are rectangular board shaped, and not deformed. The end plates 4 are coupled to the binding bars 4 at the four corners of the end plates 4, and in a state of surface contact with the flat secondary battery 1, surface contact portions are uniformly pressed by the predetermined binding pressure (P2). The end plates 4 are positioned at both ends of the battery staked member 9, and the end plates 4 is pressed by a press machine, and then the flat secondary batteries 1 are compressed. Further, holding a state that the flat secondary batteries 1 are compressed in the stacked direction, the binding bars 5 are coupled to the four corners in this state, and then the flat secondary batteries 1 are compressed and fixed in the predetermined binding pressure (P2). After the binding bars 5 coupling, the pressed state by the press machine is released.

The binding bars 5 are metal boards each having a L-shape in a lateral sectional view, and at both ends, the binding bars 5 have end edge plates 5A. The end edge plates 5A are coupled to L-shaped end surfaces of the binding bars 5, and contact the outer side surfaces of the end plates 4. The end edge plates 5A are disposed at the outer side surfaces of the end plates 4, and the binding bars 5 are coupled to the end plates 4. The end edge plates 5A of the binding bars 5 are coupled to the end plates 4, and by the end plates 4, the flat secondary batteries 1 are fixed in the compressed state. Further, the binding bars 4 are fixed to the outer surface of the end plates 4 by screw or the like. In the above battery pack 100, both ends of the binding bars 5 are coupled to a pair of the end plates 4, and the battery staked member 9 is sandwiched between the end plates 4, and each of the flat secondary batteries 1 are compressed by the predetermined binding pressure (P2), and are fixed in the pressed state in the stacked direction. The binding pressure (P2) of the flat secondary battery 1 is a pressing force per unit area which is put on both surfaces of the flat secondary battery 1. Therefore, the binding pressure (P2) is calculated by [the pressing force that the end plates 4 press the battery staked member 9 in the stacked direction]/[area of a flat portion of the flat secondary battery 1]. The binding pressure (P2) is set at preferably equal to or more than 10 kPa, equal to or less than 1 MPa. When the binding pressure (P2) is too weak, the swell of the flat secondary battery 1 is not effectively suppressed or reduced. Conversely, when the binding pressure (P2) is too strong, problem that the outer case 12 of the flat secondary battery 1 is damaged, occurs. Therefore, the binding pressure (P2) is set at an optimum value in the above range, considering type or size of the flat secondary battery, further material, shape, wall thickness, size, swell property of the electrode assembly, or the like.

The above flat secondary battery 1 is manufactured in the following steps.

### (Winding Step)

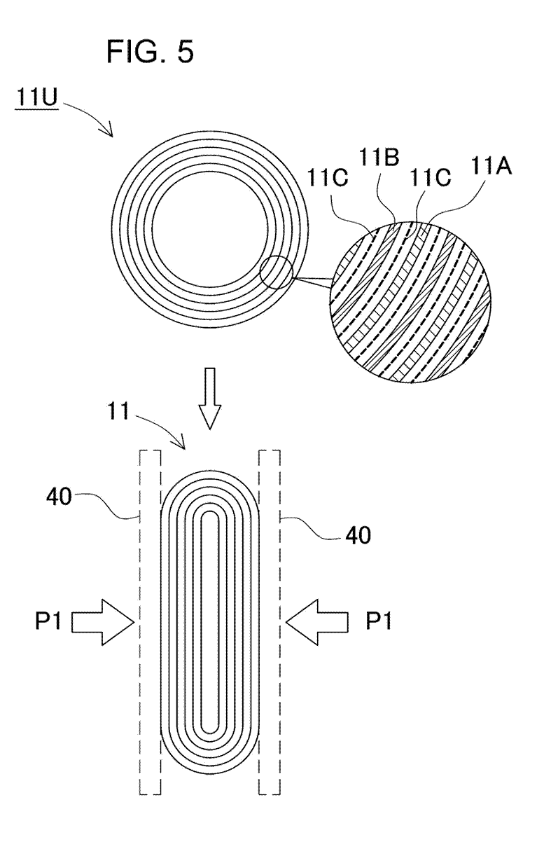

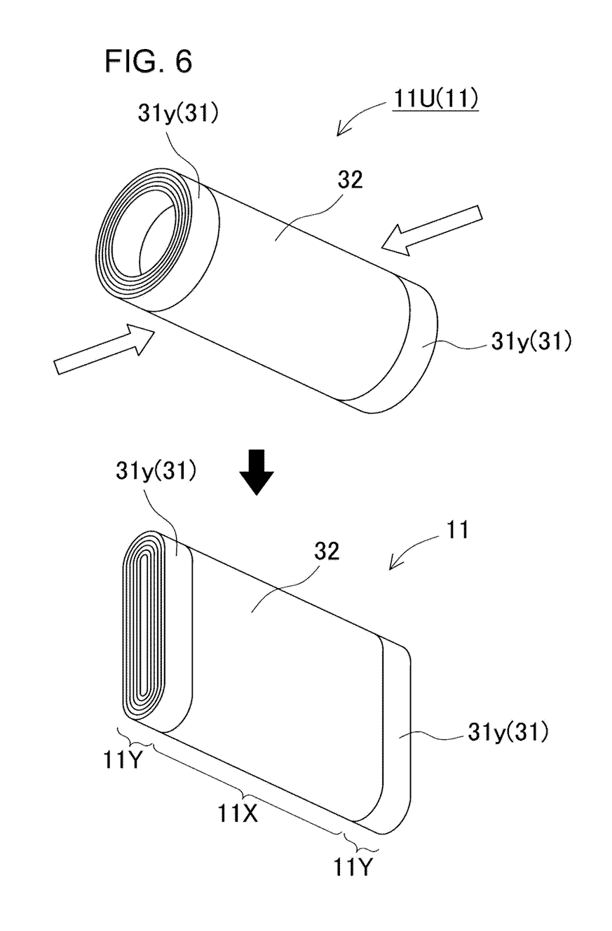

The positive electrode plate 11A and the negative electrode plate 11B interposing separators 11C therebetween are wound into the spiral form, and then the spiral electrode assembly 11U shown in FIG. 5 and FIG. 6 is made.

### (Pressed Shaping Step)

As shown in FIG. 5 and FIG. 6, the spiral electrode assembly 11U obtained in the winding step is pressed into the electrode assembly of the flat shape by a predetermined pressure. Further, in this pressed shaping step, the spiral electrode assembly can also be pressed into the flat shape in a heated state.

### (Sealing Step)

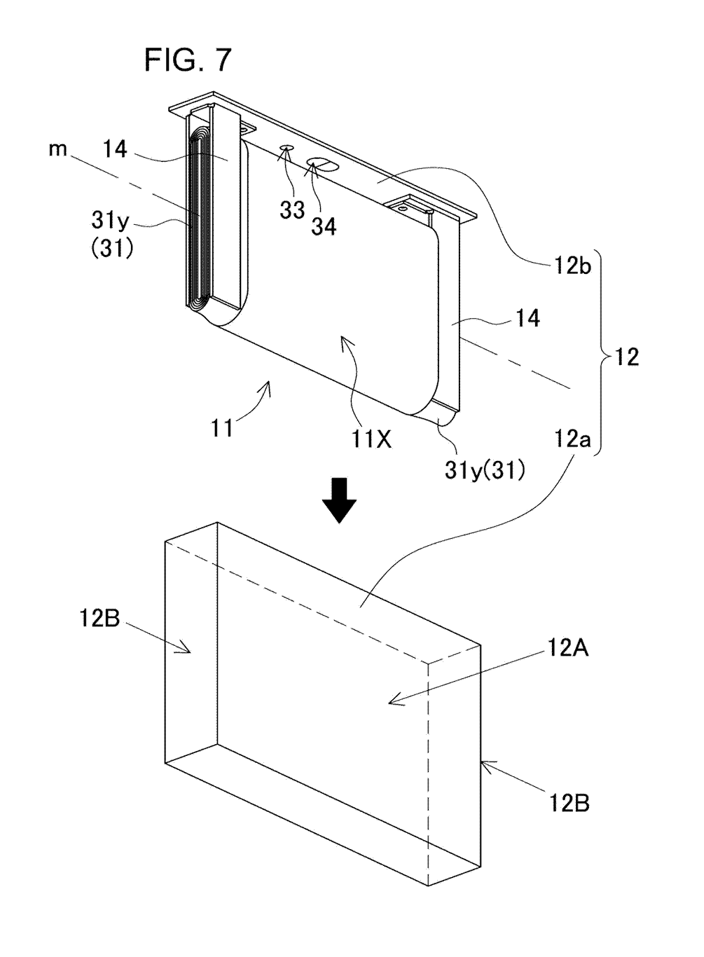

The electrode assembly 11 of the flat shape obtained in the pressed shaping step is inserted into the outer can 12a of the flat shape as shown in FIG. 7, and in a state that the electrolyte (not shown in the figures) is injected, the outer case 12 is airthightly sealed, and then the flat secondary battery 1 is obtained.

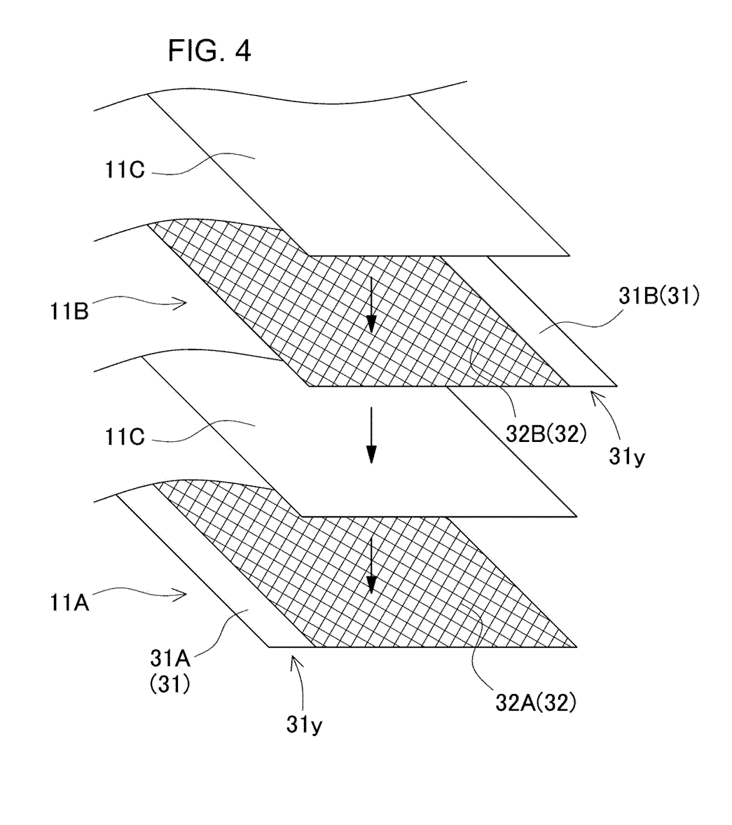

In the flat secondary battery 1 manufactured in the above steps, as shown in FIG. 4, the mixture of an active material 32, a conductive agent, and a binder is formed on the surfaces of a core 31, and the positive plate 11A and the negative plate 11B are made. The positive plate 11A and the negative plate 11B are stacked interposing separators 11C therebetween, and this is wound as shown in FIG. 5 and FIG. 6, and a spiral electrode assembly 11U is made (winding step). This spiral electrode assembly 11U is pressed into an electrode assembly 11 of a flat shape (pressed shaping step). As shown in FIG. 7, the electrode assembly 11 of the flat shape is inserted into an outer can 12a of a flat shape, the opening of the outer can 12a is airtightly sealed by the sealing plate 12B. Further, the outer case 12 is filled with the electrolyte. After a sealing plate 12b is weld-fixed to an opening portion of the outer can 12a, the electrolyte is injected into the outer can 12a through an injection hole 33 of the sealing plate 12a. After the injection of the electrolyte, the injection hole 33 is airtightly closed. Here, after the injection of the electrolyte, in the flat secondary battery 1, the opening portion of the outer can 12a can be closed by the sealing plate 12.

The non-aqueous electrolyte battery is suitable for the flat secondary battery 1. A lithium ion secondary battery is suitable for the non-aqueous electrolyte battery. The battery pack in which the flat secondary battery 1 is the lithium ion secondary battery of the non-aqueous electrolyte battery can increase a charging capacity with respect to volume and weight of the battery staked member 9. In the present invention, the flat secondary battery is not specified by the lithium ion battery of the non-aqueous electrolyte battery, and all rechargeable batteries, for example, such as, the non-aqueous electrolyte battery other than the lithium ion battery, a nickel hydride battery, a nickel cadmium battery, or the like can be applied to the present invention.

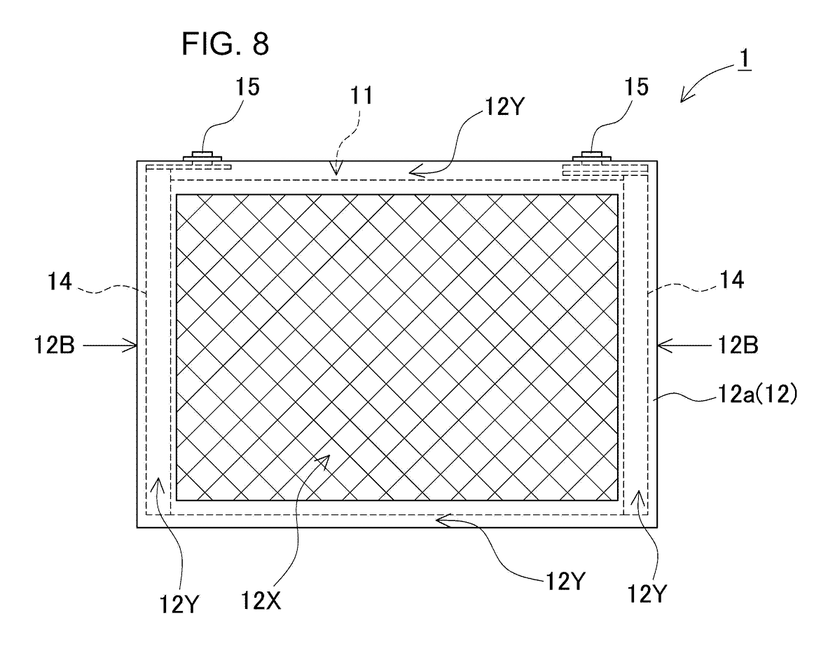

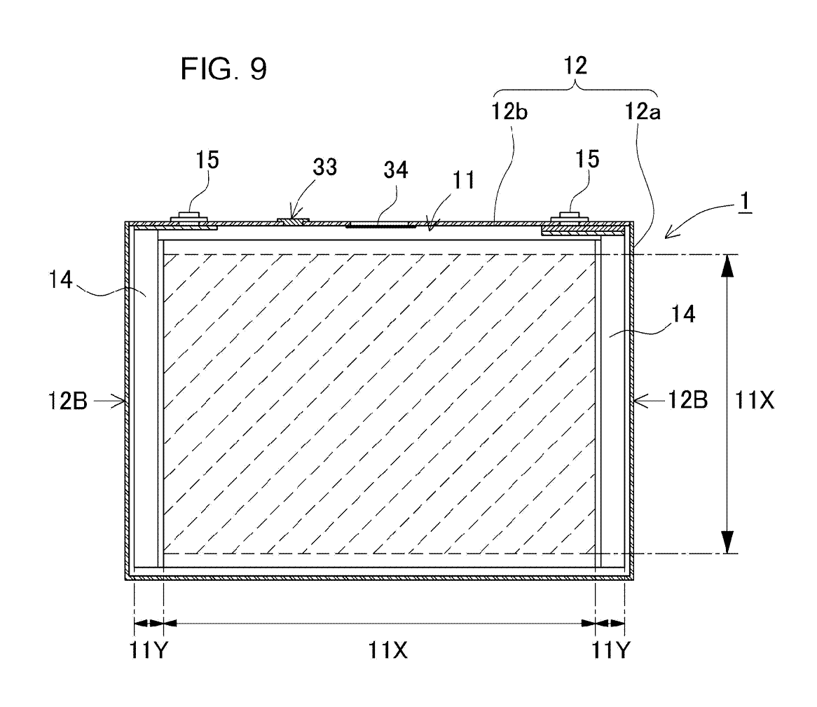

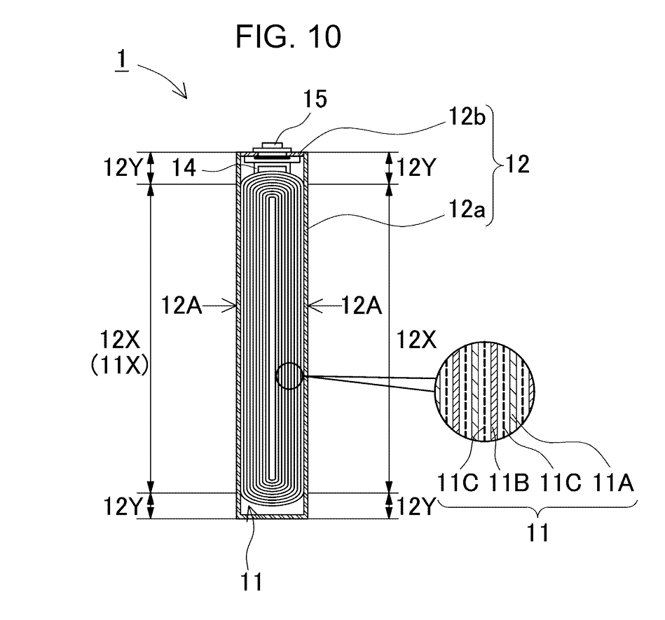

FIG. 8 to FIG. 10 show the flat secondary battery 1 of the lithium ion secondary battery. In the flat secondary battery 1 of these figures, the sealing plate 12b is weld-fixed to the opening portion of the outer can 12a, and the opening portion of the outer can 12a is airtightly sealed by the sealing plate 12b. The outer can 12a has a bottom portion closing a bottom, and a tubular shape of both facing surfaces being wide flat surfaces 12A, and the opening portion which opens upward in the figures. The outer can 12a of this shape is made by pressing a metal board, for example, such as, aluminum, aluminum alloy, or the like.

A positive or negative electrode terminal 15 is insulated from the sealing plate 12b, and is fixed at both end portions of the sealing plate 12a. The positive or negative electrode terminal 15 is connected to the positive or negative core 31 of the electrode assembly 11 which is disposed inside the outer can 12a through current collector 14. Further, the sealing plate 12b has a safety valve 34 which opens its valve when the internal pressure is increased up to a predetermined pressure. As the outer shape of the sealing plate 12b is approximately the same as the inner shape of the opening portion of the outer can 12a, the sealing plate 12b is inserted into the opening portion of the outer can 12a, and a laser beam is irradiated to a boundary between the sealing plate 12b and the outer can 12a, and the opening portion of the outer can 12a is airtightly sealed.

In the electrode assembly 11 of FIG. 4 to FIG. 6, the positive plate 11A and the negative plate 11B interposing separators therebetween are wound, and it is pressed by two of pressing plates 40, and the flat spiral electrode assembly in which facing surfaces are flat surface is made with a predetermined thickness. In the electrode assembly 11 of the flat shape by press, its thickness is the about same as the inner width of narrow width faces 12B of the outer can 12a, it is inserted inside the outer can 12a. After the flat shape of the electrode assembly 11 is inserted in the outer can 12a, the electrolyte (not shown in the figures) is injected, and after that, the opening portion of the outer can 12a is airtightly sealed.

As shown in FIG. 4, in the positive electrode plate 11A and the negative electrode plate 11B used in the electrode assembly 11, the cores 31 having a long narrow strip shape, are coated with the positive electrode active material 32A or the negative electrode active material 32B. Lithium transition-metal composite oxides that can reversibly adsorb and desorb lithium ions as the positive electrode active material 32A of the lithium ion secondary battery can be used. As the lithium transition-metal composite oxides that can reversibly adsorb and desorb lithium ions, for example, lithium cobalt oxide (LiCoO₂), lithium manganite (LiMnO₂), lithium nickel oxide (LiNiO₂), a lithium-nickel-manganese composite oxide (LiNi₁₋ₓMnₓO₂(0<x<1)), a lithium-nickel-cobalt composite oxide (LiNi₁₋ₓCoₓO₂(0<x<1)), a lithium-nickel-cobalt-manganese composite oxide (LiNiₓMn_{y}Co_{z}O₂(0<x<1, 0<y<1, 0<z<1, x+y+z=1)), or the like can be used. Further, material in which Al, Ti, Zr, Nb, B, Mg, or Mo is added to the above lithium transition-metal composite oxides can be used. For example, a lithium transition-metal composite oxide expressed by Li₁₊ₐNiₓCo_{y}Mn_{z}M_{b}O₂ (0≦a≦0.2, 0.2≦x≦0.5, 0.2≦y≦0.5, 0.2≦z≦0.4, 0≦b≦0.02, a+b+x+y+z=1, and M is at least one element selected from the group consisting of Al, Ti, Zr, Nb, B, Mg, and Mo) can be used. A filling density of the positive electrode plate 11A is preferably 2.5 to 2.9 g/cm³, more preferably 2.5 to 2.8 g/cm³. Here, the filling density of the positive electrode plate 11A means that the filling density of the positive electrode mixture layer containing the positive electrode active material 32A without the positive electrode core 31A.

The positive electrode plate 11A is preferably prepared in the following. Li₂CO₃ and (Ni_{0.35}Co_{0.35}Mn_{0.3})₃O₄ were mixed such that Li and (Ni_{0.35}Co_{0.35}Mn_{0.3}) were in the ratio of 1:1 by mol. Thereafter, this mixture was calcined at 900° C. for 20 hours in the atmosphere of the air, and a lithium transition-metal composite oxide expressed by LiNi_{0.35}Co_{0.35}Mn_{0.3}O₂ was obtained as the positive electrode active material 32A. The above positive electrode active material 32A, a flaky graphite and a carbon black as a conductive agent, and a powder of polyvinylidene fluoride (PVdF) as a binder were mixed in the ratio of 88:7:2:3(=lithium transition-metal composite oxide:flaky graphite:carbon black:PVdF) by mass. The resultant mixture was dispersed in N-methyl-2-pyrrolidone (NMP) to make a positive electrode mixture slurry. This positive electrode mixture slurry was coated on one surface of a 15 μm(=micrometer) thick positive electrode core 31A made of aluminum alloy foil, and by drying and eliminating NMP used as a solvent at the time of making the slurry, a positive electrode mixture layer containing the positive electrode active material was formed. In the same way, the positive electrode mixture layer containing the positive electrode active material was formed on the other surface of the aluminum alloy foil. After that, it was pressed with a roll press, and by cutting it into the predetermined size the positive electrode plate 11A was made.

As the negative electrode active material 32B of the lithium ion secondary battery, carbon material that can reversibly adsorb and desorb lithium ions can be used. As the carbon material that can reversibly adsorb and desorb lithium ions, graphite, non-graphitized carbon, easily graphitizable carbon, glassy carbon, coke, carbon black or the like can be used.

The negative electrode plate 11B is preferably prepared in the following.

The artificial graphite as the negative electrode active material 32B, carboxymethylcellulose (CMC) as a thickener, and styrene-butadiene rubber (SBR) as a binder were mixed in the ratio of 98:1:1 by mass, and the mixture was dispersed in water to make a negative electrode mixture slurry. This negative electrode mixture slurry was coated on one surface of a 10 μm(=micrometer) thick negative electrode core 31B made of copper foil, and by drying and eliminating water used as a solvent at the time of making the slurry, a negative electrode mixture layer containing the negative electrode active material was formed. In the same way, the negative electrode mixture layer containing the negative electrode active material was formed on the other surface of the copper foil. After that, it was pressed with a roll press.

As the separator 110, a thermoplasticity resin film of porous membrane can be used. Polyolefin material of porous membrane, for example, polypropylene (PP), polyethylene (PE), or the like is suitable for the separator 11. Further, three layer structure of polypropylene (PP) and polyethylene (PE) (PP/PE/PP, or PE/PP/PE) can be used as the separator 110.

As non-aqueous solvent of non-aqueous electrolyte, kinds of carbonate, lactone, ether, ketone, ester or the like which are commonly used in a non-aqueous electrolyte secondary battery can be used, and equal to or more than two kinds of those non-aqueous solvent can be used in combination. Among these, kinds of carbonate, lactone, ether, ketone, ester or the like is preferable, and a kind of carbonate is more preferable.

For example, cyclic carbonates such as ethylene carbonate, propylene carbonate, butylene carbonate, or the like, and chain carbonates such as dimethyl carbonate, ethyl methyl carbonate, diethyl carbonate, or the like can be used. Especially It is desirable that cyclic carbonates and chain carbonates are mixed. Further, unsaturated cyclic ester of carbonic acid of vinylene carbonate (VC) or the like can be added to the non-aqueous electrolyte.

Lithium salts commonly used as the electrolyte salt in a non-aqueous electrolyte secondary battery can be used as electrolyte salts in the non-aqueous solvent. For example, LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂),₃, LiAsF₆, LiClO₄, Li₂B₁₀Cl₁₀, Li₂B₁₂Cl₁₂ , LiB(C₂O₄)_{2,}, LiB(O₂O₄) F_{2,}, LiP(C₂O₄)₃, LiP(C₂O₄)₂F_{2,}, LiP(C₂O₄)F₄, or the like and mixtures of them can be used. Among them, especially LiPF₆ is desirable. The amount of electrolyte salt dissolved in the non-aqueous solvent is preferably 0.5 to 2.0 mol/L.

The electrode assembly 11 of FIG. 4 to FIG. 6 has exposed core portions 31y which are not coated with positive electrode active material 32A or negative electrode active material 32B at one side portions. Except these one side portions, the cores 31 are coated with the positive electrode active material 32A or the negative electrode active material 32B. The core 31 is a metal foil having conductivity. The positive plate 11A and the negative plate 11B have exposed core areas 11Y at opposite side portions, and the areas which are coated with the positive electrode active material 32A or the negative electrode active material 32B are facing, and the positive plate 11A and the negative plate 11B are wound interposing the separators 110 therebetween in a spiral form. As shown in FIG. 5, the wound spiral electrode assembly 11U is pressed into the flat shape by the pressing plates 40 in a predetermined press pressure (P1) stronger than the binding pressure of the flat secondary batteries 1 (P2). The press pressure (P1) by which the wound spiral electrode assembly 11U is pressed into the flat shape, is preferably equal to or more than twice the binding pressure (P2) of the flat secondary batteries by the end plates 4 coupled to the binding bars 5, and is more preferably equal to or more than five times, and further more preferably equal to or more than seven times, and as a value of the pressure, equal to or more than 1 M Pa, and equal to or less than 20 M Pa. When the press pressure (P1) is too strong, insulation can be broken by closer position between the positive electrode plate 11A and the negative electrode plate 11B, or the porosity of the separator 11C is low, and then it decreases the battery property. In contrast, when the press pressure (P1) is too weak, the positive electrode plate 11A and the negative electrode plate 11B are not close, or spaces of the cores between the positive electrode plate 11A and the negative electrode plate 11B are dispersed. In such cases, the battery property of the flat secondary battery 1 is not a designed property. Therefore, the press pressure (P1) is set at the optimum value in the above range, considering an insulating property of the positive electrode plates 11A and the negative electrode plate 11B, the porosity of the separator 11C, the thickness or materials of the positive electrode plates 11A and the negative electrode plate 11B, the required battery property, or the like

As mentioned above, the electrode assembly 11 of the flat shape by pressed shaping has the exposed core areas 11Y at the opposite side portions, and an active material coating area 11X therebetween. In the exposed core areas 11Y at the opposite side portions in the electrode assembly, at one side, the core 31 of the positive electrode plate 11A is exposed, and at the other side, the core 31 of the negative electrode plate 11B is exposed. The exposed core portions 31y of the positive electrode plate 11A is stacked each other without the separator, and is connected to the current collector 14 of the positive electrode plate 11A. The exposed core portions 31y of the negative electrode plate 11B is stacked each other without the separator, and is connected to the current collector 14 of the negative electrode plate 11B. The current collector 14 of the positive electrode plate 11A and the current collector 14 of the negative electrode plate 11B are each connected by welding, etc., to the electrode terminals 15 of the positive electrode plate 11A or the negative electrode plate 11B which is fixed to the sealing plate 12b.

As mentioned above, the electrode assembly 11 of the flat shape by pressed shaping is stored in the outer can 12a in a posture that an winding axis m of the spiral form is disposed in parallel with the sealing plate 12b. The exposed core areas 11Y at the opposite side portions are disposed at both sides of the outer can 12a, namely at both sides of the wide flat surface 12A of the outer can 12a of the flat shape. The electrode assembly 11 of the flat shape by pressed shaping is inserted in the outer can 12a, and the sealing plate 12a is disposed at the opening portion of the outer can 12a. The sealing plate 12b is coupled to the electrode assembly 11 through the current collectors 14. In this state, as the electrode assembly 11 is disposed in spaced relationship with the inner surface of the sealing plate 12b, a predetermined space is provided between the electrode assembly 11 and the sealing plate 12b. The sealing plate 12b which is disposed at the opening portion of the outer can 12a is welded by laser, etc., to the opening portion of the outer can 12a. After that, the electrolyte is injected through the injection hole 33 of the sealing plate 12b into the outer can 12a, and the injection hole 33 is airtightly closed.

In the above flat secondary battery, both sides and upper and lower portions of the wide flat surface 12A of the outer can 12a as an active material non-contact area 12Y do not contact the active material coating area 11X. An area except both sides and upper and lower portions of the wide flat surface 12A as an active material contact area 12X contacts the active material coating area 11X. Both sides of the wide flat surface 12A of the outer can 12a face the exposed core area 11Y, and become the active material non-contact area 12Y which does not contact the active material coating area 11X. In the upper portion of the wide flat surface 12A, there is no electrode assembly 11 at its inner surface, or the upper portion of the wide flat surface 12A does not contact the active material coating area 11X because there is a curved portion of the spiral form in the electrode assembly 11. The lower portion of the wide flat surface 12A does not contact the active material coating area 11X because there is a curved portion of the spiral form in the electrode assembly 11. The upper and lower portions of the wide flat surface 12A become the active material non-contact area 12Y.

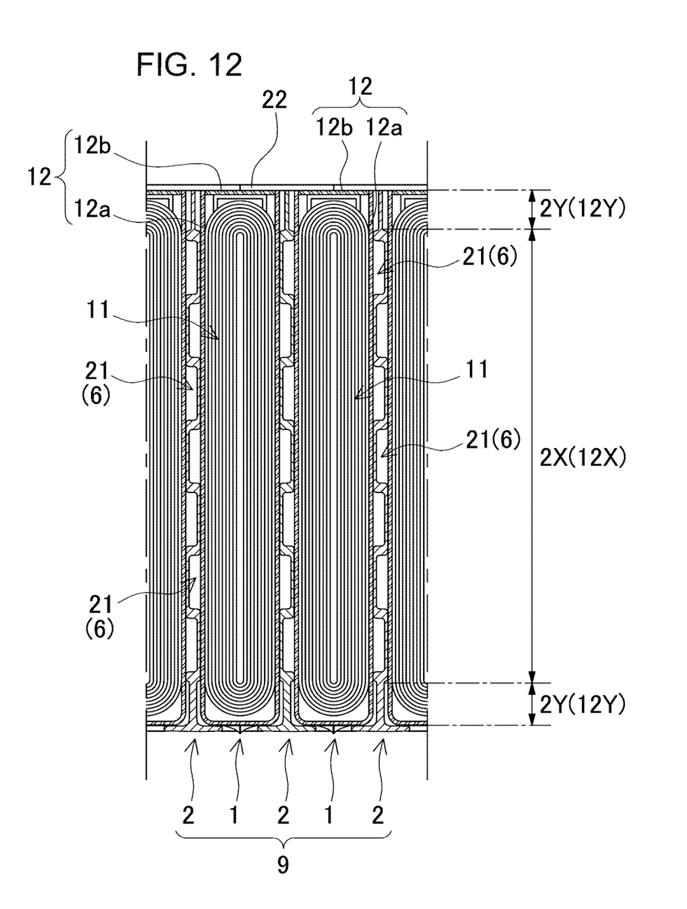

The insulating members 2 which are sandwiched and fixed between the flat secondary battery 1, are made by molding out of insulating plastic. The insulating members 2 shown in a plan view of FIG. 12, have the approximately same outer flat shape as the flat secondary battery 1, and at the four corner portions, guide walls 22 which dispose the flat secondary battery 1 inside at a fixed position, are provided. The guide walls 22 are L-shaped, and the corner portions are disposed inside the guide walls 22, and the flat secondary battery 1 is disposed at the fixed position.

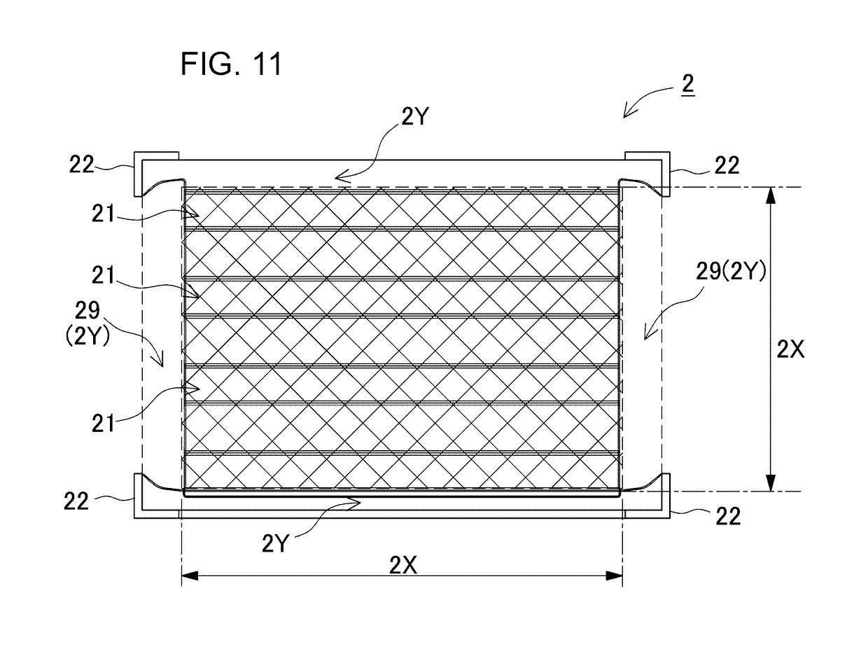

The insulating member 2 of FIG. 11 has an active material pressing portion 2X which presses the active material contact area 12X of the outer can 12a more strongly than the active material non-contact area 12Y, at the center portion (shown in the figure by cross-hatching) except both side portions and upper or lower portion. In a state that the active material pressing portion 2X presses the active material contact area 12X more strongly than the active material non-contact area 12Y, the battery stacked member 9 is compressed and fixed by a pair of the end plates 4.

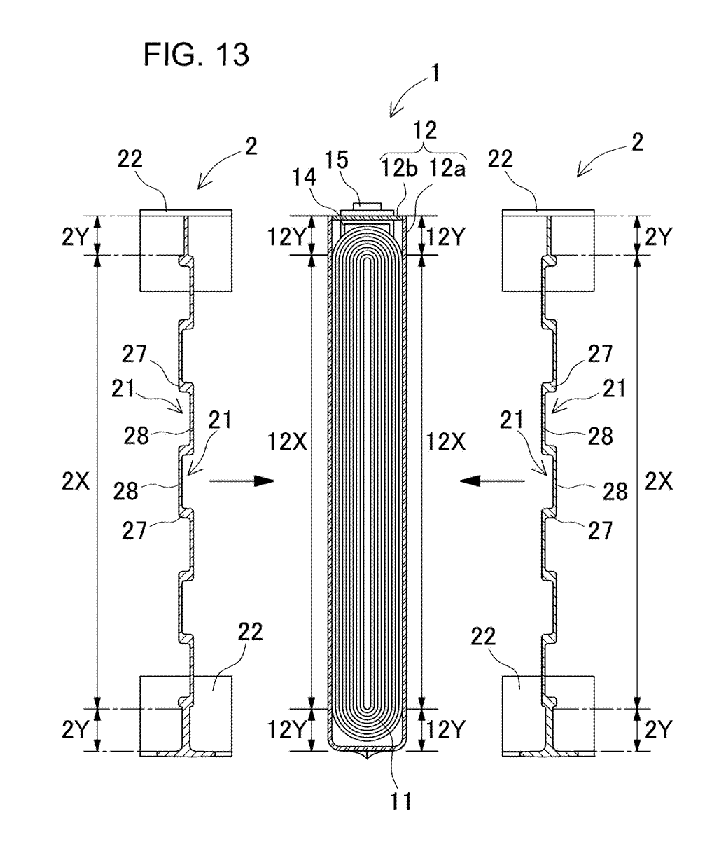

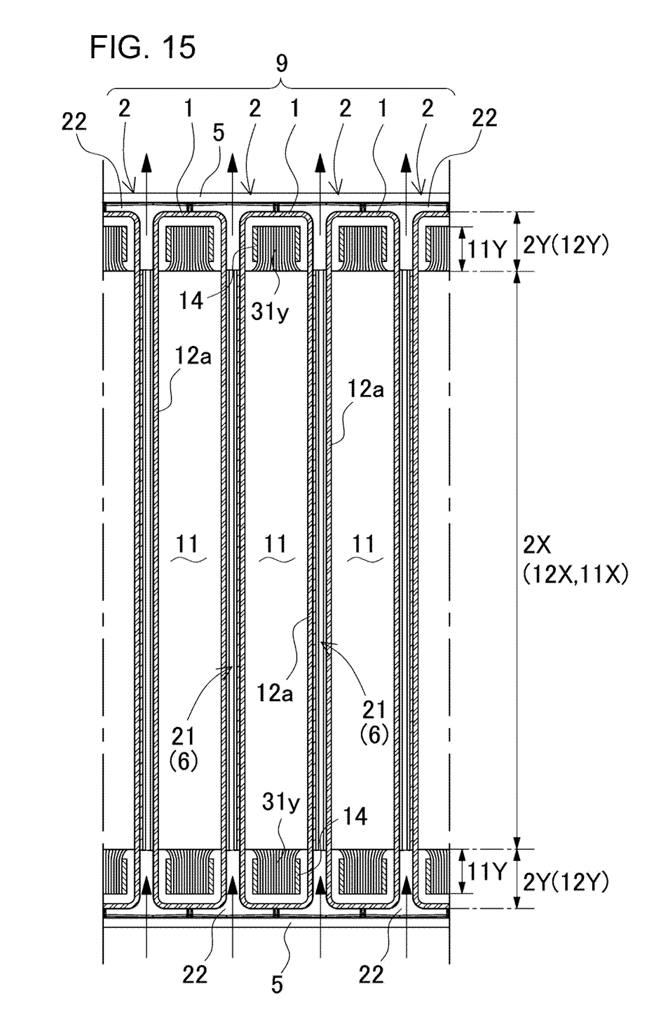

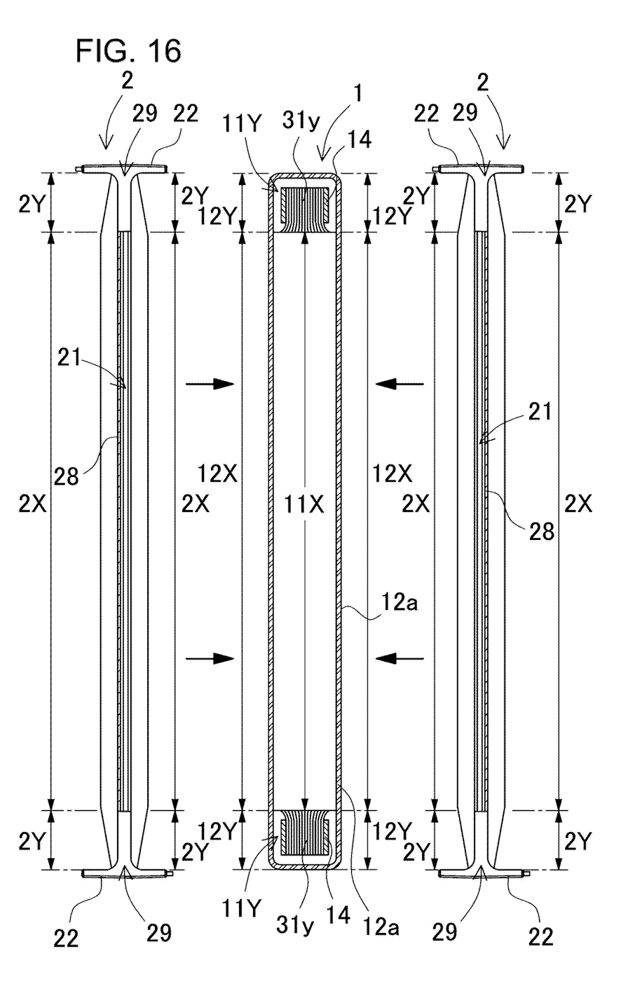

In the flat secondary battery 1 of FIG. 8, both side portions and the upper and lower portions of the wide flat surface 12A are active material non-contact areas 12Y which do not contact the active material coating area 11X. The insulating members 2 of FIG. 11 to FIG. 14 has an active material pressing portion 2X except both side portions and the upper and lower portions thereof, and non-pressing portions 2Y which do not strongly press the wide flat surface 12A at both side portions and the upper and lower portions thereof. In the insulating members 2 of FIG. 15 and FIG. 16 has cutouts 29 as non-pressing portions 2Y at facing portions to active material non-contact areas at both side portions of the wide flat surface 12A of the outer can 12a, and lower portions than the active material pressing portion 2X as non-pressing portions 2Y facing portions to the upper and lower portions of the wide flat surface 12A of the outer can 12a, The boundary between the cutouts 29 of the non-pressing portions 2Y and the active material pressing portion 2X is located at the boundary between the active material coating area 11X and the exposed core area 11Y of the electrode assembly, the active material pressing portion 2X presses or pushed the active material contact area 12X of the outer can 12a.

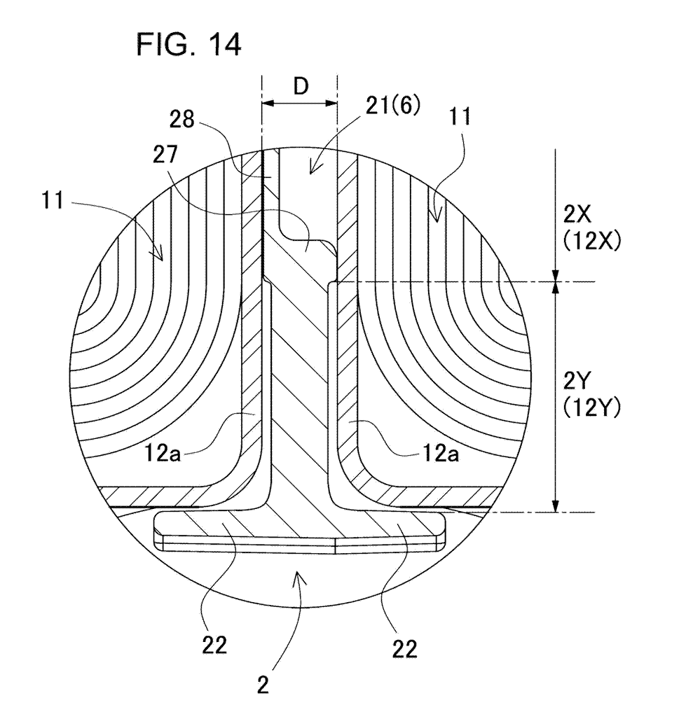

As shown in the enlarged sectional view of the FIG. 14, in the insulating member 2, the active material pressing portion 2X projects more than the non-pressing portions 2Y provided at the upper and lower portions, and strongly presses or pushes the active material contact area 12X of the outer can 12a. The active material pressing portion 2X projects more than the non-pressing portions 2Y, for example, by 0.2 mm. Here, the active material pressing portion 2X projects more than the non-pressing portions 2Y, for example, by equal to or more than 0.1 mm and equal to or less than 0.5 mm, and can strongly press or pushes the active material contact area 12X. The insulating members 2 are sandwiched and fixed between the flat secondary batteries 1, and press or push the active material contact area 12X. Therefore, the insulating member 2 has the active material pressing portion 2X on both surfaces thereof, and presses or pushes the active material contact areas 12X of the flat secondary batteries stacked on both surfaces thereof. As the insulating member 2 has the active material pressing portions 2X on both surfaces thereof at the same position, portions where the active material pressing portions 2X are provided, are thicker than the non-pressing portions 2Y.

Further, the insulating members 2 shown in FIG. 11 to FIG. 14, have plural rows of cooling spaces between the flat secondary batteries 1 stacked on both surfaces thereof. The flat secondary batteries 1 can be forcibly cooled by forcibly blowing cooled air of cooling mechanism (not shown in the figures) to the cooling spaces 6 of the insulating members 2. Plural rows of cooling grooves 21 are provided alternately on both surfaces of the insulating members 2, and bottom boards 28 of the cooling grooves 21 tightly contact the outer can 12a of the opposite flat secondary battery 1. In the insulating member 2, the height of facing walls 27 positioned at both sides of the cooling grooves 21 is substantial thickness (D) of the active material pressing portion 2X. Therefore, in the insulating member 2, the substantial thickness (D) of the active material pressing portion 2X can be adjusted by the height of the facing walls 27, and the projecting value (or height) from the non-pressing portions 2Y is controlled. In this insulating member 2, the flat secondary batteries 1 can be forcibly cooled by forcibly blowing cooled air to the cooling spaces 6 of the insulating members 2. But the insulating member does not necessarily need to have the cooling spaces, and also have a flat surface or an approximately flat surface as the pressing portion, and then can press the active material contact area of the outer can. Further, the insulating member, the active material pressing portion highly projects, and it can more strongly press the center portion of the active material contact area. Therefore, as the swell of the electrode assembly 11 is effectively reduced or suppressed by the insulating member 2, it is not necessary to make the binding pressure by the end plates 4 and the binging bars 5 stronger than necessary. Therefore, for example, the deformation or the like of the outer case 12 of the flat secondary battery 1 can be prevented.

The above battery pack is assembled in the following steps.
(1) The insulating members 2 are sandwiched between plural flat secondary batteries 1, and the battery stacked member 9 is obtained.
(2) The end plates 4 are positioned at both ends of the battery staked member 9, and the end plates 4 is pressed by the press machine, and the battery staked member 9 is pressed through the end plates 4 in the predetermined pressure, and the flat secondary batteries 1 are pressed and held in the pressed state.

In this state, in the insulating members 2, the active material pressing portion 2X presses the active material contact area 12X more strongly than the active material non-contact area 12Y. Namely, the active material contact area 12X of the outer can is pressed by the predetermined pressure without the active material non-contact area 12Y strongly pressed.
(3) The battery staked member 9 is held in the pressed state, and the binding bars 5 are coupled to a pair of the end plates 4, and then the flat secondary batteries 1 and the insulating members 2 are compressed and fixed in the pressed state.
(4) In the pressed state of the battery staked member 9, bus bars 13 are coupled to the electrode terminals 15 of the flat secondary batteries 1. The bus bars 13 connect the flat secondary batteries 1 in series, or in series and parallel. The bus bars 13 are welded and fixed to the electrode terminals 15, or are fixed by screw.

When in the battery pack assembled in the above state, by using, the active material 32 of the electrode assembly 11 is swollen and the active material coating area 11X is swollen, the active material contact area 12X of the outer can 12a which the active material coating area 11X contacts, is pressed or pushed by the active material pressing portion 2X of the insulating member 2, and the swell of the active material coating area 11X can be prevented. Especially, as the active material contact area 12X of the outer can 12a is pressed or pushed more strongly than the active material non-contact area 12Y, while the swell of the active material coating area 11X is effectively prevented, without the upper and lower portions or both side portions apt to be damaged of the outer can 12a damaged, the swell of the active material coating area 11X of the electrode assembly 11 can be surely prevent.

The aforementioned battery packs can be used as a power supply for vehicles. The battery pack can be installed on electric vehicles such as hybrid cars that are driven by both an internal-combustion engine and an electric motor, and electric vehicles that are driven only by an electric motor. The battery pack can be used as a battery pack for these types of vehicles.

### (Hybrid Car Battery Pack)

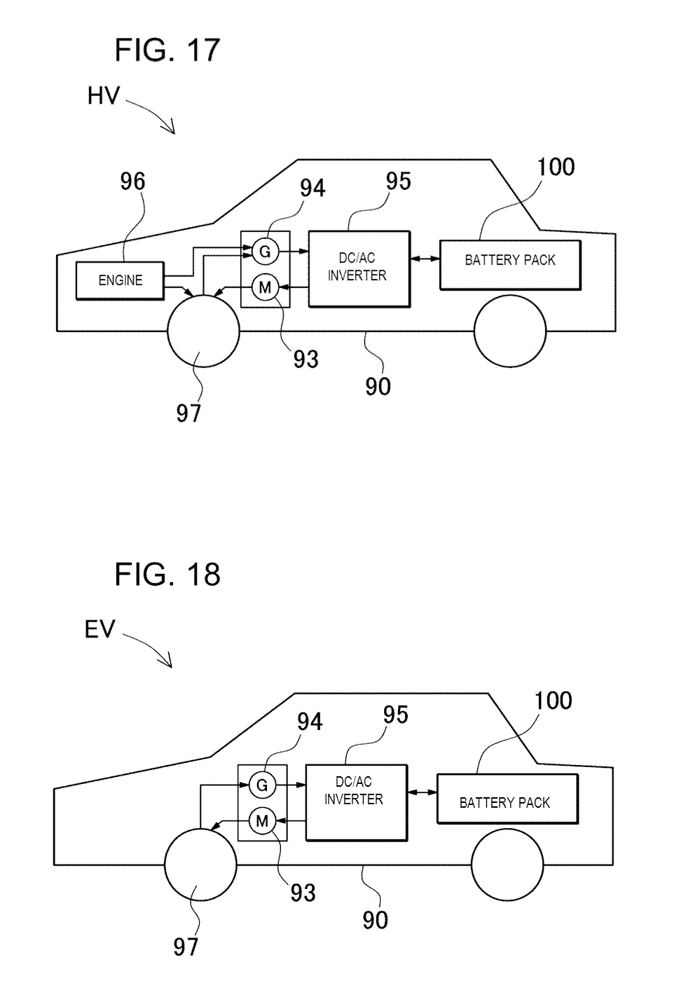

FIG. 17 is a block diagram showing an exemplary hybrid car that is driven both by an engine and an electric motor, and includes the battery pack. The illustrated vehicle HV with the battery pack includes an electric motor 93 and an internal-combustion engine 96 that drive the vehicle HV, a battery pack 100 that supplies electric power to the electric motor 93, an electric generator 94 that charges batteries of the battery pack 100, a vehicle body 90 that incorporates the engine 96, the motor 93, and the generator 94, and a wheel or wheels 97 that can be driven by the engine 96 or the electric motor 93, and drive the vehicle body 90. The battery pack 100 is connected to the electric motor 93 and the electric generator 94 via a DC/AC inverter 95. The vehicle HV is driven both by the electric motor 93 and the internal-combustion engine 96 with the flat secondary batteries of the battery pack 100 being charged/discharged. The electric motor 93 is energized with electric power and drives the vehicle in a poor engine efficiency range, e.g., in acceleration or in a low speed range. The electric motor 93 is energized by electric power that is supplied from the battery pack 100. The electric generator 94 is driven by the engine 96 or by regenerative braking when users brake the vehicle so that the flat secondary batteries of the battery pack 100 are charged.

### (Electric Vehicle Battery Pack)

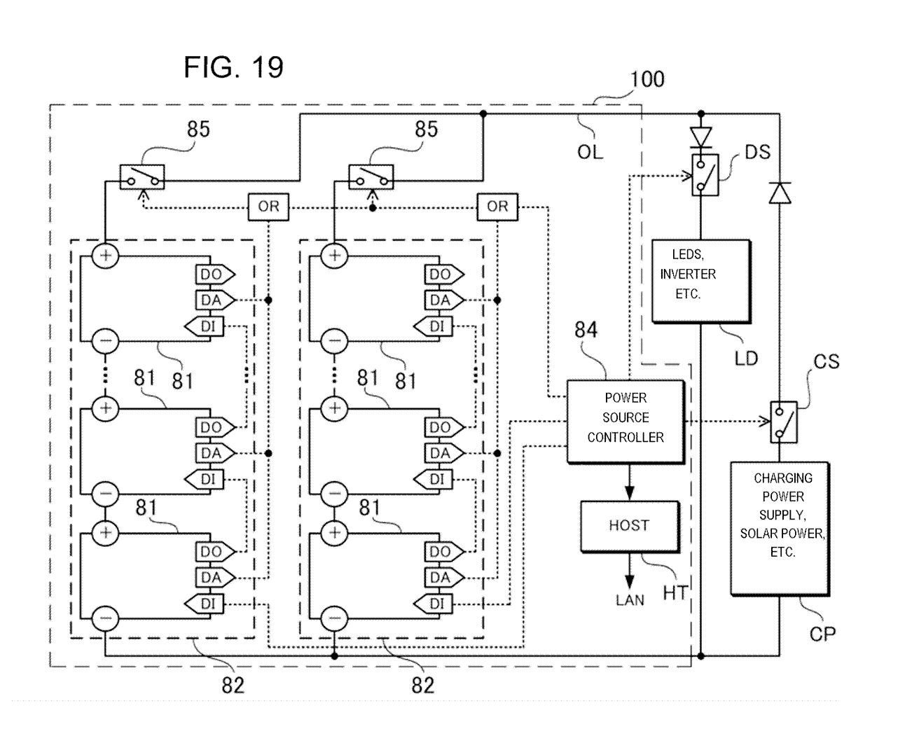

FIG. 18 shows an exemplary electric vehicle that is driven only by an electric motor, and includes the battery pack. The illustrated vehicle EV with the battery pack includes the electric motor 93, which drives the vehicle EV, the battery pack 100, which supplies electric power to the electric motor 93, the electric generator 94, which charges flat secondary batteries of the battery pack 100, a vehicle body 90 that incorporates the motor 93 and the generator 94, and a wheel or wheels 97 that can be driven by the electric motor 93, and drive the vehicle body 90. The electric motor 93 is energized by electric power that is supplied from the battery pack 100. The electric generator 94 can be driven by vehicle EV regenerative braking so that the flat secondary batteries of the battery pack 100 are charged.

### (Power Storage Type Battery Pack)

The battery pack can be used not only as power supply of mobile unit but also as stationary power storage. For example, examples of stationary power storage devices can be provided by an electric power system for home use or plant use that is charged with sunlight or with midnight electric power and is discharged when necessary, a power supply for street lights that is charged with sunlight during the daytime and is discharged during the nighttime, or a backup power supply for signal lights that drives signal lights in the event of a power failure. FIG. 19 shows an exemplary circuit diagram. This illustrated battery pack 100 includes battery units 82 each of which includes a plurality of battery packs 81 that are connected to each other. In each of battery packs 81, a plurality of rectangular battery cells 1 are connected to each other in serial and/or in parallel. The battery packs 81 are controlled by a power supply controller 84. In this battery pack 100, after the battery units 82 are charged by a charging power supply CP, the battery pack 100 drives a load LD. The battery pack 100 has a charging mode and a discharging mode. The Load LD and the charging power supply CP are connected to the battery pack 100 through a discharging switch DS and a charging switch CS, respectively. The discharging switch DS and the charging operation switch CS are turned ON/OFF by the power supply controller 84 of the battery pack 100. In the charging mode, the power supply controller 84 turns the charging operation switch CS ON, and turns the discharging switch DS OFF so that the battery pack 100 can be charged by the charging power supply CP. When the charging operation is completed so that the battery units are fully charged or when the battery units are charged to a capacity not lower than a predetermined value, if the load LD requests electric power, the power supply controller 84 turns the charging operation switch CS OFF, and turns the discharging switch DS ON. Thus, operation is switched from the charging mode to the discharging mode so that the battery pack 100 can be discharged to supply power to the load LD. In addition, if necessary, the charging operation switch CS may be turned ON, while the discharging switch DS may be turned ON so that the load LD can be supplied with electric power while the battery pack 100 can be charged.

The load LD driven by the battery pack 100 is connected to the battery pack 100 through the discharging switch DS. In the discharging mode of the battery pack 100, the power supply controller 84 turns the discharging switch DS ON so that the battery pack 100 is connected to the load LO. Thus, the load LD is driven with electric power from the battery pack 100. Switching elements such as FET can be used as the discharging switch DS. The discharging switch DS is turned ON/OFF by the power supply controller 84 of the battery pack 100. The power supply controller 84 includes a communication interface for communicating with an external device. In the exemplary battery pack shown in FIG. 19, the power supply controller is connected to a host device HT based on existing communications protocols such as UART and RS-232C. Also, the battery pack may include a user interface that allows users to operate the electric power system if necessary.

Each of the battery packs 81 includes signal terminals and power supply terminals. The signal terminals include a pack input/output terminal DI, a pack abnormality output terminal DA, and a pack connection terminal DO. The pack input/output terminal DI serves as a terminal for providing/receiving signals to/from other battery packs and the power supply controller 84. The pack connection terminal DO serves as a terminal for providing/receiving signals to/from other battery packs as slave packs. The pack abnormality output terminal DA serves as a terminal for providing an abnormality signal of the battery pack to the outside. Also, the power supply terminal is a terminal for connecting one of the battery packs 81 to another battery pack in series or in parallel. In addition, the battery units 82 are connected to an output line OL through parallel connection switches 85, and are connected in parallel to each other.

### INDUSTRIAL APPLICABILITY

A battery pack according to the present invention can be suitably used as battery packs of plug-in hybrid vehicles and hybrid electric vehicles that can switch between the EV drive mode and the HEV drive mode, electric vehicles, and the like. A vehicle including this battery pack according to the present invention can be suitably used as plug-in hybrid vehicles, hybrid electric vehicles, electric vehicles, and the like. Also, a battery pack according to the present invention can be suitably used as backup power supply devices that can be installed on a rack of a computer server, backup power supply devices for wireless communication base stations, electric power storages for home use or plant use, electric power storage devices such as electric power storages for street lights connected to solar cells, backup power supplies for signal lights, and the like.

1. A battery pack comprising:
a battery staked member stacking a plurality of flat secondary batteries;
end plates being disposed at both ends of the battery staked member; and
binding bars being coupled to the end plates in a pressed state that the flat secondary batteries of the battery staked member are compressed and fixed in a predetermined binding pressure,
the flat secondary batteries constituting the battery staked member, comprising;
an electrode assembly of a spiral form in which a positive electrode plate and a negative electrode plate interposing a separator therebetween are wound; and
an outer case airtightly storing the spiral electrode assembly and an electrolyte,
wherein the spiral electrode assemblies of the flat secondary batteries are pressed and made into a flat shape by a higher pressing pressure than the predetermined binding pressure in which the flat secondary batteries are bound by the binding bars.

2. The battery pack according to claim 1, wherein the flat secondary batteries are non-aqueous electrolyte secondary batteries.

3. The battery pack according to claim 2, wherein the non-aqueous electrolyte secondary batteries are lithium ion secondary batteries.

4. The battery pack according to claim 1, wherein the pressing pressure of the spiral electrode assemblies is equal to or more than twice the binding pressure of the flat secondary batteries.

5. The battery pack according to claim 1, wherein the separator of the electrode assembly is a thermoplasticity resin film of porous membrane.

6. The battery pack according to claim 1,
wherein the outer case comprises an outer can having an opening portion and a sealing plate, and the opening portion of the outer can is airtightly sealed and closed by the sealing plate by laser welding,
wherein the pressed electrode assembly is stored in the outer can in a posture that an winding axis of the spiral form is disposed in parallel with the sealing plate.

7. The battery pack according to claim 1,
wherein the end plate is a rectangular shape as a whole shape, and the end plates are coupled to the binding bars at the four corners thereof.

8. The battery pack according to claim 7, wherein the binding bar is a metal board having a L-shape in a lateral sectional view.

9. A method for manufacturing a battery pack comprising:
a winding step of winding into a spiral electrode assembly a positive electrode plate and a negative electrode plate interposing a separator therebetween;
a pressed shaping step of pressing the spiral electrode assembly obtained in the winding step into a flat pressed spiral electrode assembly;
a sealing step of airtightly sealing an outer case in a state that the flat pressed spiral electrode assembly obtained in the pressed shaping step is inserted in the outer case and an electrolyte is filled into the outer case, as flat secondary batteries;
a stacking step of stacking a plurality of the flat secondary batteries obtained in the sealing step as a battery staked member; and
a binding step of binding and fixing in a pressed state of the flat secondary batteries of the battery staked member in a predetermined pressure by disposing end plates at both ends of the battery staked member obtained in the stacking step and coupling a pair of binding bars to the end plates,
wherein the spiral electrode assemblies of the pressed shaping step are pressed and made by a stronger pressing pressure than the binding pressure by which the flat secondary batteries are compressed in the binding step.

10. The method for manufacturing the battery pack according to claim 9, wherein the flat secondary batteries are non-aqueous electrolyte secondary batteries.

11. The method for manufacturing the battery pack according to claim 10, wherein the non-aqueous electrolyte secondary batteries are lithium ion secondary batteries.

12. The method for manufacturing the battery pack according to claim 9,
wherein the pressing pressure of the spiral electrode assembly in the pressed shaping step is equal to or more than 1 M Pa, and equal to or less than 20 M Pa, and this pressing pressure is equal to or more than twice the binding pressure of the flat secondary batteries in the binding step.

13. A vehicle equipped with the battery pack according to claim 1, comprising:
an electric motor being energized by electric power that is supplied from the battery pack;
a vehicle body having the power supply device and the electric motor; and
a wheel being driven by the electric motor, and driving the vehicle body.

14. A storage battery device equipped with the battery pack according to claim 1, comprising:
a power supply controller controlling charging and discharging of the battery pack,
wherein the battery pack is charged with an external power by the power supply controller, and charging of the power supply device is controlled by the power supply controller.
